(19) United States
(12) Patent Application Publication
(10) Pub. No.: US 2026/0214509 A1
(43) Pub. Date: Jul. 23, 2026

(54) INTERACTIVE PACKET SECURITY SYSTEM MODULATING AND DEMODULATING IMAGE SUPERPIXEL BITS

(71) Applicant: TIA CO., LTD., GWANGJU (KR)

(72) Inventors: LEE JIN JIN, Gwangsan-gu, Gwangju (KR); SAN MIN JIN, Gwangsan-gu, Gwangju (KR); HA NEUL JIN

(21) Appl. No.: 19/140,047

(22) PCT Filed: Jun. 24, 2024
(86) PCT No.: PCT/KR2024/008666

§ 371 Date: Jun. 17, 2025

(30) Foreign Application Priority Data
Aug. 3, 2023 (KR) 10-2023-0101804

(51) Int. Cl. H04W 28/06; G06T 5/50; G06T 5/60; G06V 10/74; G06V 10/82; H04W 12/033

(52) U.S. Cl. CPC H04W 28/065; G06T 5/50; G06T 5/60; G06V 10/761; G06V 10/82; H04W 12/033; G06T 2207/10024; G06T 2207/20021; G06T 2207/20081; G06T 2207/20084; G06T 2207/20221

(57) ABSTRACT

The present disclosure relates to an interactive packet security system modulating and demodulating image superpixel bits. The present disclosure provides a Packet Security system using Image Fragments (PSIF) platform for packet security targeting 5G wireless networks and can provide an effect of dividing a communication packet into blocks and transmitting them through multiple paths in a datagram-based manner of packet switching methods, and of making it possible to obtain original data by reconstructing the communication packet by matching corresponding pieces and combining the data of the blocks at a receiving node when one image is fragmented and transmitted along with each block.

### FIELD OF THE INVENTION

The present disclosure relates to an interactive packet security system modulating and demodulating image superpixel bits.

### BACKGROUND OF THE INVENTION

With the advancement of 5G and IoT, an increasing amount of personal information is being transmitted and received via wireless communication, thereby increasing the need for wireless communication security.

Further, as the emergence of quantum computers and ternary computers becomes more tangible, the risk of hacking in existing packet encryption methods is increasing. Furthermore, even as the 5G era unfolds and brings larger packet sizes, security threats related thereto may still persist.

Accordingly, in this technical field, as a significant amount of personal information is transmitted via wireless communication due to the IoT adoption of various devices, the necessity for wireless communication security is increasing and the risk of hacking in existing packet encryption methods is also growing. Accordingly, it is required to develop technologies that provide more complex security solutions than existing encryption methods.

### Prior Art Document

Korean Patent No. 10-1510472 (Apparatus and method for securing data packet in wireless sensor network)

### SUMMARY OF THE INVENTION

In order to solve the problems described above, an objective of the present disclosure is to enhance security by dividing communication packets into blocks in a datagram-based manner and transmitting them through multiple paths, by preventing complete packet data from being obtained with only some of the transmission lines and block data, and by making it difficult to reassemble image fragments unless an image processing module and an image merging algorithm of a pixel lossless technique are used.

Further, an objective of the present disclosure is to provide a platform that can reduce the transmission time of image data by overcoming the drawback of mathematical encryption methods that require a long time and by utilizing the fact that values change each time when images are divided into a random number of segments using the inherent numerical values of image channels.

The objectives of the present disclosure are not limited to those described above and other objectives may be made apparent to those skilled in the art from the claims.

In order to achieve the objectives, the present disclosure includes: a transmission host 100 providing a Packet Security system using Image Fragments (PSIF) platform for packet security targeting 5G wireless networks, and dividing a communication packet into blocks and transmitting the blocks through a plurality of paths in a datagram-based manner of packet switching methods, while simultaneously dividing a single image at a pixel level and transmitting image fragments with the packet blocks, respectively; a packet security server 300 providing an original image and the divided images to a reception host after performing a comparison and verification process; and a reception host 400 combining data received from the transmission host such that communication packet is reconstructed to be able to obtain original data by combining the packet blocks by matching corresponding pieces at a receiving node,
wherein the transmission host 100 includes: an image processing module 100a performing image division (fragmentation) such that an original image has a form having a predetermined number of pieces, and sequentially loading a unique number (terminal identification number), a departure time for packet transmission (packet order number), and transmission data divided into an image piece of a random size into each packet block together with an image fragment; an AI module 100b learning the result of a restoration process of original data acquired by the reception host and applying the learning result to a process for a next image fragment; a transceiver 110 designating the original image before division as a correct answer set and transmitting data packet blocks, which are the transmission data, through the 5G network 200 to the packet security server 300 in a datagram-based manner in which path selection is independently performed into a plurality of paths; and a storage device 200 storing the original image and the divided image,
wherein the reception host 400 includes: a transceiver 410 receiving the data packet blocks transmitted through the 5G network; a storage unit 420 sequentially storing the data packet blocks transmitted through the 5G network; an AI module 400b analyzing the data packet blocks transmitted through the 5G network and performing image restoration for lost image pieces to be similar to an original using GAN that is a deep learning technology; and an image processing module 400a receiving an image through the AI module 400b, comparing the image with a merged image completed using unique numbers assigned to image fragments (terminal identification numbers, etc.) and an image merging algorithm, and performing primary verification using image boundary information of image fragments through an SLIC method of a super pixel algorithm and secondary verification through a process of comparing modified pixels with an original image using unique values of RGBA channels of each pixel of an image,
wherein the image processing module 400a compares quantized values for uniformity, compactness, and boundary adherence to an original image of pixels between image grids, and obtains original data by combining adjacent packet blocks through a lossless pixel technique using an image merging algorithm.

Further, the image processing module 400a of the present disclosure checks whether image pieces transmitted by each terminal have been received and then determines whether there is any missing image; records information of a terminal that has lost an image in the storage device 420 and performs merging with the lost image left empty; and restores the portion with the image lost to resemble an origin through deep learning GAN and performs a verification process.

Further, if a merged image is not the same as an original image or if even one pixel of the merged image is modified, the verification method of the present disclosure finds the modified pixels by comparing them with the original image, and then outputs the result where the modified pixel locations are visualized in red.

Further, the verification process of the present disclosure further includes checking a verification result by also outputting a result where a boundary of an image piece that is transmitted the modified pixel is visualized in blue.

Further, the quantization of the present disclosure, which converts continuous color values into discrete values, performs quantization using an SLIC algorithm and creates a new small region by grouping pixels of an original image; the SLIC algorithm divides an original image into grids of a predetermined size and then groups each region using characteristics such as a distance, a color, etc. of pixels in each grid using a superpixel technique; and, in this process, each pixel is quantized using a color value, a distance, etc. that are close to a superpixel that the pixel belongs to.

Further, in order to solve packet block errors, when a packet block is lost and cannot be restored due to a communication error of some data in the packet block, the reception host 400 retransmits the received lost packet block to the transmission host 100 to retransmit a packet block from the storage device, which has a DB of a packet block having the same coordinate information as the retransmitted packet block, to solve errors.

The present disclosure has an effect of enhancing security by dividing communication packets into blocks in a datagram-based manner and transmitting them through multiple paths, by preventing complete packet data from being obtained with only some of the transmission lines and block data, and by making it difficult to reassemble image fragments unless an image processing module and an image merging algorithm of a pixel lossless technique are used.

Further, the present disclosure has an effect of being able to provide a platform that can reduce the transmission time of image data by overcoming the drawback of mathematical encryption methods that require a long time and by utilizing the fact that values change each time when images are divided into a random number of segments using the inherent numerical values of image channels.

### BRIEF DESCRIPTION OF THE DRAWINGS

FIG. 1 is a configuration diagram illustrating an interactive packet security system 1 modulating and demodulating image superpixel bits according to an embodiment of the present disclosure.

FIG. 2 is a block diagram illustrating the components of a transmission host 100 and a reception host 400 in the interactive packet security system 1 modulating and demodulating image superpixel bits according to an embodiment of the present disclosure.

FIG. 3 is a configuration diagram illustrating the operation process of the interactive packet security system 1 modulating and demodulating image superpixel bits according to an embodiment of the present disclosure.

FIG. 4 is a configuration diagram for explaining a datagram-based manner through a routing process of packet blocks in the interactive packet security system 1 modulating and demodulating image superpixel bits according to an embodiment of the present disclosure.

FIG. 5 is a diagram for explaining image changes for each image superpixel in the interactive packet security system 1 modulating and demodulating image superpixel bits according to an embodiment of the present disclosure.

### DETAILED DESCRIPTION OF THE INVENTION

Hereafter, preferred embodiments of the present disclosure will be described in detail with reference to the accompanying drawings. In the following description of the present disclosure, detailed descriptions of well-known functions or configurations relating to the present disclosure will not be provided when it is determined that they may unnecessarily obscure the point of the present disclosure.

In this specification, when a certain component “transmits” data or a signal to another component, it means that the component may directly transmit the data or signal to the other component or may transmit the data or signal to the other component through at least one additional component. In addition, in this specification, the term “fragmentation of an image” is used in the same sense as “division of an image”.

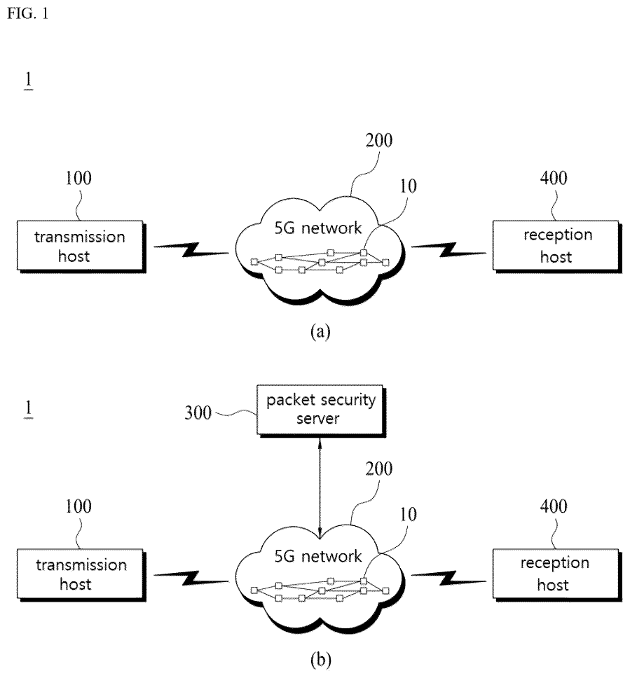

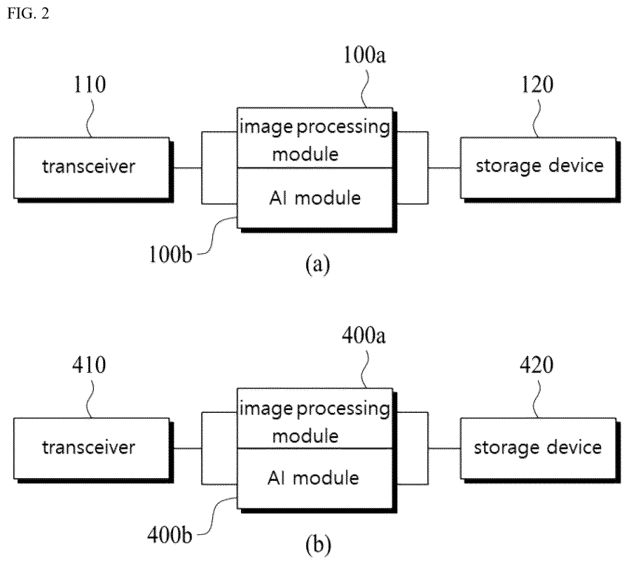

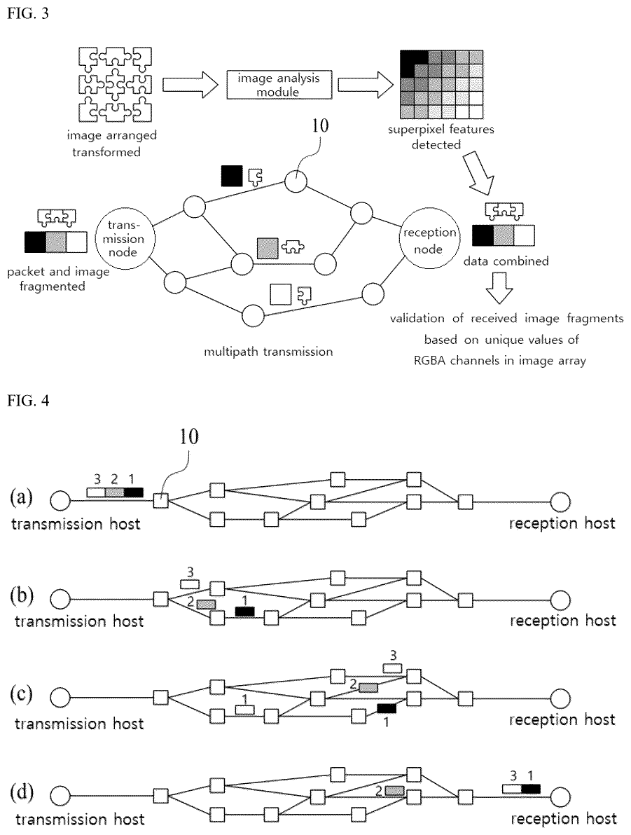

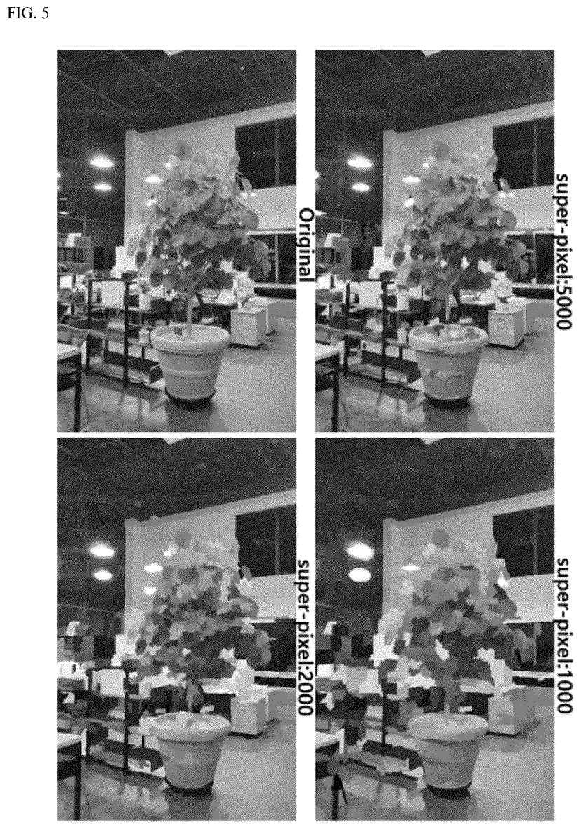

FIG. 1 is a diagram illustrating an interactive packet security system 1 modulating and demodulating image superpixel bits according to an embodiment of the present disclosure. FIG. 2 is a block diagram illustrating the components of a transmission host 100 and a reception host 400 in the interactive packet security system 1 modulating and demodulating image superpixel bits according to an embodiment of the present disclosure. FIG. 3 is a diagram illustrating the operation process of the interactive packet security system 1 modulating and demodulating image superpixel bits according to an embodiment of the present disclosure. FIG. 4 is a diagram for explaining a datagram-based manner through a routing process of packet blocks in the interactive packet security system 1 modulating and demodulating image superpixel bits according to an embodiment of the present disclosure. FIG. 5 is a diagram for explaining image changes for each number of image superpixels in the interactive packet security system 1 modulating and demodulating image superpixel bits according to an embodiment of the present disclosure.

First, referring to FIG. 1 to FIG. 3, an interactive packet security system 1 modulating and demodulating image superpixel bits provides a Packet Security system using Image Fragments (PSIF) platform for packet security targeting 5G wireless networks and can provide a technology that divides a communication packet into blocks and transmits them through multiple paths in a datagram-based manner of packet switching methods and can obtain original data by reconstructing the communication packet by matching corresponding pieces and combining the data of the blocks at a receiving node when one image is fragmented and the image fragments are simultaneously transmitted along with each block.

The interactive packet security system 1 modulating and demodulating image superpixel bits of the present disclosure, as a first embodiment shown in FIG. 1a, may include a transmission host 100, a 5G network 200, and a reception host 400, and as a second embodiment shown in FIG. 1b, may include a transmission host 100, a 5G network 200, a packet security server 300, and a reception host 400.

Referring to FIG. 2, the transmission host 100 may include a transceiver 110, an image processing module 100a, an AI module 100b, and a storage device 120, and the reception host 400, similarly, may also include a transceiver 410, an image processing module 400a, an AI module 400b, and a storage device 420.

The transmission host 100 can perform image fragmentation, which divides each of multiple unspecified original images into a form having a preset number of pieces or more, through the image processing module 100a, can designate an original image before division as a correct answer set and control the transceiver 110 to divide and transmit the original image in a datagram-based manner over a plurality of paths through the 5G network 200 to the reception host 400 such that the original image is provided to the AI module 400b of the reception host 400, as in FIG. 1a, and can construct a DB in the storage device 130 for provided original images.

As another embodiment of the present disclosure, as shown in FIG. 1b, the transmission host 100 can perform image fragmentation, which divides each of multiple unspecified original images into a form (deleted) having at least a preset number of pieces or more, through the image processing module 100a, can designate an original image before division as a correct answer set and control the transceiver 110 to divisionally transmit the original image through a plurality of paths to the packet security server 300 in a datagram-based manner through the 5G network 200 such data is created on the basis of deep learning at the packet security server 300 using the original image and a Super pixel (SLIC) algorithm and is provided to the AI module 400b of the reception host 400, and can construct a DB in the storage device 130 for provided original images.

In this configuration, when transmitting packet blocks formed by dividing a communication block to the reception host 400, the transmission host 100 can form blocks in the same number as the fragmented image pieces and load each packet block with a different image fragment. Further, the greater the number of fragmented image pieces on the transmission host 100, the more the security stability and security reliability can be improved.

Further, it is preferable that the transmission host 100, in the packet blocking and image segmentation process, sets the number of pieces to be divided and the number of boundary shapes, and not only prepares image pieces to be loaded into blocks, which correspond to the number of the pieces, in accordance with the set number of pieces and loads the image pieces into the blocks but also divides data to be transmitted into random byte units and sequentially loads the departure time (packet sequence number) for packet transmission and the divided data into each of the blocks.

It is preferable that the transmission host 100 performs transmission by controlling the transceiver 110 to additionally input the divided byte units and a destination (e.g., the terminal identification number of the reception host 400 and then divide and transmit the packet blocks in a datagram-based manner through a plurality of unspecified paths in the 5G network 200.

Meanwhile, the packet switching method between the transmission host 100 and the reception host 400 is a method in which an image is divided into packets of a certain size and transmitted, and each packet block is independently routed and reaches a destination. This method may be classified into two types, which are a virtual circuit and a datagram. First, the virtual circuit method divides data into packets and transmits the packets, but since it establishes a virtual connection between the transmission 100 and the reception host 400, so all packets follow the same transmission path through the same packet switch 10. In contrast, the datagram-based method according to the present disclosure is characterized in that path selection for a plurality of packet switches 10 is performed independently.

The AI module 100b may be configured to learn the result of a restoration process of original data acquired by the reception host and to apply the learning result to a process for a next image fragment.

In this case, as shown in FIG. 4d, a situation may occur in which the arrival orders of packet blocks (a first packet block 1, a second packet block 2, and a third packet block 3) change (the first packet block 1, the third packet block 3, and the second packet block 2). However, in the present disclosure, since the image processing module 400a of the reception host 400 can align the order through the unique numbers of packet blocks during a lossless pixel merging process, in which matching boundaries are seamlessly connected, it is possible to offset mismatches in the packet arrival sequence that may occur due to each packet block passing through a different number of packet switches 10.

Meanwhile, looking into the operation of the reception host 400 in detail, the reception host 400 may perform “received data combination”. In more detail, when receiving data packet blocks received through the 5G network 200 are received through the transceiver 410, the reception host 400 can not only sequentially store the data packet blocks into the storage device 430 but also analyze the image fragments respectively included in the received packet blocks in association with data provided by its own AI module 400b (FIG. 1a) or analyze them through the AI module 400b operating in conjunction with data provided by the packet security server 300 (FIG. 1b).

In the reception host 400, the image processing module 400a compares an original image provided through the AI module 400b with a merged image completed using the unique numbers assigned to image fragments (terminal identification numbers, etc.) and an image merging algorithm.

First, through the SLIC method of the super pixel algorithm, primary verification is performed using the image boundary information of image fragments, and secondary verification is performed through a process of comparing modified pixels with an original image using the unique values of RGBA channels of each pixel.

In this case, the reception host 400 checks whether the image pieces transmitted by each terminal have been received, and then determines whether there is any missing image. The information of the terminals that have lost images is recorded in the storage device 420, and merging is performed with the corresponding image pieces left empty. The empty portions are restored to resemble the original image through deep learning GAN, and undergo a verification process. If a merged image is not the same as an original image or if even one pixel of the merged image is modified, the verification method finds the modified pixel by comparing it with the original image and then outputs the result where the location of the modified pixel is visualized in red. Additionally, the verification result can be checked by also outputting the result where the boundary of the image piece that transmitted the modified pixel is visualized in blue.

That is, the interactive packet security system 1 modulating and demodulating image superpixel bits according to the present disclosure provides a packet security platform on the basis of image sampling and quantization, in which “sampling” performed by the transmission host 100 may refer to determining the location information of an image as digital data, and since sample points are represented as pixels, the sampling can be simply said that the transmission host 100 “divides an image into pixels”, and the smaller the interval of division, the higher the sampling, and the larger the interval, the lower the sampling.

The “quantization” performed by the reception host 400 refers to “converting continuous color values into discrete values”, and the quantization is carried out by the SLIC algorithm that is used in the present disclosure. Superpixels are based on a technique that creates new small regions by grouping the pixels of an original image, and in this case, the SLIC algorithm divides the original image into grids of a predetermined size and then groups each region as one superpixel using characteristics such as the distance, color, etc. of the pixels in each grid. In this process, each pixel is quantized using a color value, a distance, etc. that are close to the superpixel it belongs to.

The reception host 400 can perform quantization using image processing when matching image fragments, can compare them with an original image using the characteristics of superpixels, and can take advantage of the fact that it is difficult to find correct pieces without using an appropriate comparison module. Further, the more pieces the image is divided into, the higher the security, and at the same time, the reliability of matching correct images can be increased.

Meanwhile, the reception host 400 cannot obtain complete packet data with only block data through some paths, and can obtain packet data only when the number of image fragments matches block data through all paths, whereby security can be enhanced.

In order to solve packet block errors, when a packet block is lost and cannot be restored due to various factors such as a communication error of some data in the packet block, the reception host 400 retransmits the received lost packet block to the transmission host 100 to find and retransmit the packet block from the data record stored in the storage device 120 of the transmission host 100, which has the same coordinate information as the retransmitted packet block, whereby the speed of error resolution can be ensured.

In the reception host 400, for image fragments matched by the processing module 400a, AI-based location information using data received through the AI module 400b is searched from an original image and then inserted. In this case, in order to verify whether incorrect image fragments have been combined or pixel information has been changed due to malfunctions, the received image fragments are merged into a single image using a lossless pixel technique and then the merged image can be filtered by comparing it with the original image in the unit of pixel-channel (RGBA) values, thereby being able to provide the advantage of enabling rapid filtering.

The present disclosure may be implemented as computer-readable codes in a computer-readable recording medium. The computer-readable medium includes all kinds of recording devices that keep data that can be read by a computer system.

The computer-readable recording medium, for example, may be a ROM, a RAM, a CD-ROM, a magnetic tape, a floppy disk, and an optical data storage device, and includes a carrier wave (for example, transmission through the internet).

Further, the computer-readable recording medium may be distributed to computer systems that are connected through a network, and may keep and execute codes that can be divisionally read by computers. Further, functional programs, codes, and code segments for implementing the present disclosure may be easily inferred by programmers in the art.

As described above, exemplary embodiments of the present disclosure were disclosed in the specification and drawings, but it should be understood that the embodiments are merely used to easily explain the present disclosure and helping understand the present disclosure without limiting the scope of the present disclosure. It is apparent to those skilled in the art that the present disclosure may be modified in various ways on the basis of the spirit of the present disclosure other than the embodiments described herein.

What is claimed is:

1. An interactive packet security system modulating and demodulating image superpixel bits, the interactive packet security system comprising:
a transmission host 100 providing a Packet Security system using Image Fragments (PSIF) platform for packet security targeting 5G wireless networks, and dividing a communication packet into blocks and transmitting the blocks through a plurality of paths in a datagram-based manner of packet switching methods, while simultaneously dividing a single image at a pixel level and transmitting image fragments with the packet blocks, respectively;
a packet security server 300 providing an original image and the divided image to a reception host after performing a comparison and verification process; and
a reception host 400 combining data received from the transmission host such that communication packet is reconstructed to be able to obtain original data by combining the packet blocks by matching corresponding pieces at a receiving node,
wherein the transmission host 100 includes:
an image processing module 100a performing image division (fragmentation) such that an original image has a form having a predetermined number of pieces, and sequentially loading a unique number (terminal identification number), departure time for packet transmission (packet order number), and transmission data divided into an image piece of a random size into each packet block together with an image fragment;
an AI module 100b learning the result of a restoration process of original data acquired by the reception host and applying the learning result to a process for a next image fragment;
a transceiver 110 designating the original image before division as a correct answer set and transmitting data packet blocks, which are the transmission data, through the 5G network 200 to the packet security server 300 in a datagram-based manner in which path selection is independently performed into a plurality of paths; and
a storage device 200 storing the original image and the divided image,
wherein the reception host 400 includes:
a transceiver 410 receiving the data packet blocks transmitted through the 5G network;
a storage unit 420 sequentially storing the data packet blocks transmitted through the 5G network;
an AI module 400 b analyzing the data packet blocks transmitted through the 5G network and performs image restoration for lost image pieces to be similar to an original using GAN that is a deep learning technology; and
an image processing module 400a receiving an image through the AI module 400b, comparing the image with a merged image completed using unique numbers assigned to image fragments (terminal identification numbers) and an image merging algorithm, and performing primary verification using image boundary information of image fragments through an SLIC method of a super pixel algorithm and secondary verification through a process of comparing modified pixels with an original image using unique values of RGBA channels of each pixel of an image,
wherein the image processing module 400a compares quantized values for uniformity, compactness, and boundary adherence to an original image of pixels between image grids, and obtains original data by combining adjacent packet blocks through a lossless pixel technique using an image merging algorithm.

2. The interactive packet security system of claim 1, wherein the image processing module 400a checks whether image pieces transmitted by the transmission host have been received and then determines whether there is any missing image; records information of a terminal that has lost an image in the storage device 420 and performs merging with the lost image left empty; and restores the portion with the image lost to resemble an origin through deep learning GAN and performs a verification process.

3. The interactive packet security system of claim 2, wherein when the origin and the merged image are not the same or even one pixel of the merged image is modified, the verification process finds the modified pixel by comparing the pixel with an original image, and then outputs a result where the location of the pixel is visualized in red.

4. The interactive packet security system of claim 3, wherein the verification process further includes checking a verification result by also outputting a result where a boundary of an image piece that transmitted the modified pixel is visualized in blue.

5. The interactive packet security system of claim 1, wherein the quantization, which converts continuous color values into discrete values, performs quantization using an SLIC algorithm and creates a new small region by grouping pixels of an original image; the SLIC algorithm divides an original image into grids of a predetermined size and then groups each region using characteristics such as a distance, a color, etc. of pixels in each grid using a superpixel technique; and, in this process, each pixel is quantized using a color value, a distance, etc. that are close to a superpixel the pixel belongs to.

6. The interactive packet security system of claim 1, wherein in order to solve packet block errors, when a packet block is lost and cannot be restored due to a communication error of some data in the packet block, the reception host 400 retransmits the received lost packet block to the transmission host 100 such that the transmission host 100 retransmits a packet block from the storage device 120, which has a DB of a packet block having the same coordinate information as the retransmitted packet block, to the reception host 400 to restore the packet block.
